(19) United States
(12) Patent Application Publication
(10) Pub. No.: US 2011/0250334 A1
(43) Pub. Date: Oct. 13, 2011

(54) Process to control color, moisture and acrylamide in thermally processed foods

(76) Inventor: Andrew Anthony Caridis, San Carlos, CA (US)

(21) Appl. No.: 12/798,878

(22) Filed: Apr. 12, 2010

(51) Int. Cl. A23L 1/01

(52) U.S. Cl. 426/439; 426/465; 426/438; 426/455; 426/441

(57) ABSTRACT

A process for preparing a comestible product from a root vegetable, masa or fruit by first subjecting the starting product to a heating phase to reduce moisture content to a range of 3% to about 12% and then treating the product to an inert, virtually oxygen free, fast moving atmosphere at about 115° C. until reaching a moisture content in the range of 0.5% to about 2.0% for a resulting acrylamide content of under 200 ppb and thereafter supplying the finishing treatments of the food product such as weighing and packaging.

### FIELD OF THE INVENTION

The present invention relates to a process that when applied to thermally processed foods enables a reduction in acrylamide, control of product color and cooking oil pickup. It is applicable to a wide variety of food products cooked in a hot oil bath or in a toaster oven. The food products include vegetables and fruits, especially those with sugars, such as products prepared from root crops: potatoes, sweet potatoes, carrots and beets. The process is applicable to corn products: corn chips and tortilla chips.

### BACKGROUND OF THE INVENTION

Acrylamide (or acrylic amide) is a chemical compound with the chemical formula C₃H₅NO. Its IUPAC name (International Union of Pure and Applied Chemistry) is 2-propenamide. It is a white odorless crystalline solid, soluble in water, ethanol, ether and chloroform. Acrylamide also occurs in many cooked starchy foods. Acrylamide was accidentally discovered in foods in April 2002 by scientists in Sweden when they found the chemical in starchy foods, such as potato chips, French fries and bread that had been heated. Production of acrylamide in the heating process was shown to be temperature-dependent. It was not found in food that had been boiled or in foods that were not heated. Acrylamide levels appear to rise as food is heated for longer periods of time. There is still uncertainty over the precise mechanisms by which acrylamide forms in foods, but many believe it is a byproduct of the Maillard reaction. In fried or baked goods, acrylamide may be produced by the reaction between asparagine and reducing sugars (fructose, glucose, etc.) at temperatures above 120° C. (248° F.). Governmental agencies have scrutinized the presence of acrylamide in food products and on Aug. 26, 2005, the California attorney general filed a lawsuit against prominent makers of French fries and potato chips to warn consumers of the potential risk from consuming acrylamide. The lawsuit was settled on Aug. 1, 2008 with the food producers agreeing to reduce acrylamide levels in half. The settlement required the producers to reduce acrylamide to 275 parts per billion (ppb) in three years. Presently there is a need for an efficient and reliable process to produce these food products within or below that level of acrylamide content.

Workers in this art have addressed the problem of acrylamide formation in food products in several ways including extra treatment to the starting vegetables such as by blanching in hot water to remove free starches. A related approach was to carefully select a type and quality of potato with a desired sugar content that would, after cooking, lead to reduced levels of acrylamide. Another approach was to add certain amino acids to the starting materials used to make a fabricated potato chip, as disclosed in U.S. Pat. No. 7,267,834, issued Sep. 11, 2007, to V. A. Elder, et al. Still another approach was to employ a vacuum fryer to cook potato chips, the fryer being equipped with complex air locks for entry and removal of the potato chip product so as to maintain the vacuum during cooking.

Known by art workers in the food processing field are certain factors believed to contribute to acrylamide formation in thermally processed food products. It is believed that there is a direct correlation between amount of asparagines in a food product and the potential for acrylamide formation. Similarly, the amount of glucose content correlates to a higher potential of acrylamide formation. Process temperatures of 120° C. and above are necessary for acrylamide formation and the longer the food item is subjected to an elevated process temperature, the greater the amount of acrylamide formed. The higher the final moisture content in the food item the lower the acrylamide formation. During cooking, as the food product approaches the Maillard reaction, the greater the potential for acrylamide to be formed. The Maillard reaction, the font of all flavor, has the desirable aspect in developing food flavors, aromas and the distinctive tastes of cooked food products. It occurs when components such as reducing sugars, amino acids or proteins react together in the presence of heat. The Maillard reaction requires water removal during processing of food products which is necessary in producing a low moisture content food product such as potato chips and the like.

### SUMMARY OF THE INVENTION AND OBJECTS

In the inventive process, a starting product is selected from the group consisting of fruits and vegetables including potatoes, sweet potatoes, carrots, beets as well as a starting product formed from a corn masa, such products containing asparagines and simple sugars, the steps comprising: subjecting the product initially to a heating medium for a time and temperature to produce a desired color at a moisture content of the product to within the range of 3% to 12% and at a level above where production of acrylamide is accelerated, and then removing the product to an inert, circulating atmosphere maintained at a temperature below 112° C. to about 115° C. for a time in which to obtain the final desired product moisture content and then moving the resultant product to a final handling stage.

A general object of the invention is to provide a process that reliably affords production of thermally treated food products with commercially acceptable color, flavor and moisture content with an acrylamide content below 275 ppb.

Another object of the present invention is to provide a process that does not rely upon amino acid additives to the starting products or special pre-processing treatments such as hot water blanching, nor of the process of frying in a vacuum.

Yet another object of the invention is to provide a process that affords control of product color, cooking oil pickup, and acrylamide content below a level of 120 ppb.

The foregoing and further object of the invention will be become apparent from the following detailed description of the preferred embodiments.

### DETAILED DESCRIPTION (THERE IS NO DRAWING)

The principles of the present invention may be carried out through use of known equipment such as the apparatus disclosed in Patent Application Publication, No. US 2010/0021602 A1, Jan. 28, 2010, disclosing a universal potato chip cooker and U.S. Pat. No. 5,934,178 of Aug. 10, 1999, and U.S. Pat. No. 6,146,678 of Nov. 14, 2000, disclosing an air impingement oven. Such an oven is available from Heat and Control, Inc. of Hayward, Calif. under the trademark AirForce®. Each of the foregoing is hereby incorporated herein and made a part hereof as if displayed in haec verba.

A starting product may be selected from root vegetables such as potatoes, sweet potatoes, carrots, etc. Various fruits also may be chosen for preparation into a comestible food product. I prefer to start with potatoes with the intention of preparing a potato chip with low moisture content, low acrylamide content and with a color and taste associated with a commercially available chip. Potatoes are selected and delivered to a vegetable slicer commonly employed in the field to produce potato slices of the accepted thickness for potato chips. Operatively the slicer may discharge slices directly into a hot oil bath and there to be exposed to violent agitation in the initial cooking step where the moisture content of the slices are reduced to about 3% to 12% moisture. At this point in the process the slices have achieved some structure, form and color and are not merely limp and do not tend to clump together. This step may occupy 1.5 to 3 minutes of processing.

At this juncture in the process I prefer to move the slices from the initial heating medium into a chamber, like that disclosed in the '178 and '678 US Patents mentioned above, the AirForce air impingement. There the treatment chamber is charged with an inert or virtually oxygen free atmosphere and the temperature there in is held about 115° C. It is believed that with the moisture content in slice being in the 3% to 12% range and the inert atmosphere temperature maintained not over about 115° C., acrylamide formation is substantially minimized as the slice moisture content is reduced to the range of 0.5% to 2.5%. This step may occupy 5 to 35 minutes of processing.

I have compared products prepared in accordance with the above process steps with like starting products prepared with a conventional process. One distinction is that the conventional process takes a shorter time period in which to achieve the commercially acceptable product. However, when tested for acrylamide content the product from the conventional process contained 772 ppb (parts per billion) while the product from my process as disclosed herein contained 119 ppb, much below the 275 ppb level mandated in the California litigation settlement mentioned above.

The inert or substantially oxygen free atmosphere of the treatment chamber, for example that in the AirForce air impingement oven, may be established by introducing therein nitrogen readily available from commercial sources. Super heated steam at the preferred temperature of about 112° C. to about 115° C. is also readily available in food processing plants and when used as the circulating heating medium within the oven, the desired product moisture reduction is achieved while product oxidation is minimized.

For producing a corn chip with similar low acrylamide content, a masa is sheeted and cut into generally triangular shapes, although other shapes are acceptable, and dropped into the hot oil bath, agitated for a period of time until the initial product has a moisture content in the 3% to 12% range. Thus treated, the chip-to-be is placed into the air impingement oven containing the mentioned inert or virtually oxygen free atmosphere at the preferred temperature of about 112° C. to about 115° C. until the final chip moisture content reaches the range of 0.5% to 2.5%.

For producing a corn based tortilla chip with similar low acrylamide content, masa is sheeted and cut into generally triangular shapes, although many other shapes are acceptable, and placed in a toaster oven such as that disclosed in U.S. Pat. No. 6,408,842, issued Jun. 25, 2002, to A. Herrera as well as in an Odyssey Oven™ toaster oven manufactured by Casa Herrera, 2655 North Pine. St., Pomona, Calif. 91767. The corn based chip-to-be is not fully processed in the toaster oven but is removed as the moisture content of the product reaches the range 3% to 12% range and then is introduced into the inert atmosphere and temperature such as that provided in the air impingement oven. The product is maintained in this second treatment atmosphere and temperature until the desired final moisture content is realized, the range of about 0.5% to 2.5%

It will be readily apparent that various modifications may be made to the processes of this invention and still be within the scope of the present invention. Accordingly, the scope of this invention shall only be limited within terms and spirit of the following claims.

What is claimed is:

1. In a process of preparing a thermally processed food product without the use of chemical additives or blanching from a starting product taken from the group consisting of root products such as potatoes, sweet potatoes, carrots, beets, and fruit products such as apples and corn masa, the steps including
subjecting the starting product to a heating medium for a time and temperature to reduce the moisture content of the product to within the range of 3% to 12% and to develop the desired color in the product,
removing the product from the initial heating medium and then placing the product in a subsequent treatment medium wherein the temperature is in the range below 112° C. to about 115° C. for a period of time to reduce the moisture content of the product to within the range of about 0.5% to about 2.5% and the acrylamide level in the product is maintained below about 200 ppb,
and then removing the product from the subsequent treatment medium for final handling steps.

2. The process of claim 1 wherein the initial heating medium is cooking oil which is attracted to the product and said subsequent treatment medium serves to remove cooking oil from the product.

3. The process of claim 1 where the initial heating medium is a toaster oven followed by a cooking oil medium, followed by an inert atmosphere at a temperature below 115° C. and the product is a tortilla chip.

4. The process of claim 2 where the product is a potato chip.

5. The process of claim 1 wherein said subsequent treatment medium comprises an inert, non-oxidizing atmosphere circulated around the product.

6. The process of claim 5 wherein said subsequent treatment medium comprises super-heated steam.

7. The process of preparing a fried food product from a starting product taken from the group consisting of root products such as potatoes, sweet potatoes, carrots and beets and fruits such as bananas, plantains, and apples, the steps including
frying the starting product in a hot oil bath for a time and temperature sufficient to reduce the moisture content of the product to above the range of 3% to 12% and to develop the desired color in the product and at a temperature level above where production of acrylamide is accelerated,
removing the product from the hot oil bath and then placing the product in a subsequent treatment medium wherein the temperature is controlled to be in the range below 112° C. to about 115° C. for a period of time to reduce the moisture content of the product to within the range of about 0.5% to about 2.5% moisture and the acrylamide level in the product is maintained below about 200 ppb,
and then removing the product from the subsequent treatment medium for final handling steps.

8. The process of claim 7 wherein the subsequent treatment medium serves to control oxidation and is a circulating, inert gas atmosphere.

9. The process of claim 7 wherein the subsequent treatment medium is circulating, super-heated steam to control oxidation.

10. In a thermally process food containing asparagines and simple sugars, the steps comprising: subjecting the product initially to a heating medium for a time and temperature to produce a desired color at a moisture content of the product to within the range of 3% to 12% and at a level above where production of acrylamide is accelerated,
and then removing the product to an inert, circulating atmosphere maintained at a temperature below 112° C. to about 115° C. for a time in which to obtain the final desired product moisture content.

11. The process of claim 10 wherein the resultant product contains an acrylamide content of below 200 ppb (parts per billion).

12. The process of claim 1 wherein the initial heating medium is cooking oil, followed by presenting the product to an inert atmosphere at a temperature below 115° C. and the product is a corn chip.
